(19) United States
(12) Patent Application Publication
(10) Pub. No.: US 2022/0379450 A1
(43) Pub. Date: Dec. 1, 2022

(54) MULTITOOL SURVIVAL DEVICE

(71) Applicant: Jennifer Ingianni, Phillipsville, CA (US)

(72) Inventor: Jennifer Ingianni, Phillipsville, CA (US)

(21) Appl. No.: 17/335,883

(22) Filed: Jun. 1, 2021

(51) Int. Cl. B25F 1/00; F21L 4/08; H02J 7/35; F21V 33/00; B26B 1/02

(52) U.S. Cl. CPC B25F 1/006; F21L 4/085; H02J 7/35; F21V 33/0004; B26B 1/02

(57) ABSTRACT

A multitool survival device, including a main body, a glass breaker disposed on at least a portion of the main body to shatter at least a portion of a glass surface in response to moving the glass breaker against the glass surface, a seatbelt cutter disposed on at least a portion of the main body to cut a seatbelt of a vehicle in response to moving the seatbelt cutter against the seatbelt, a compass disposed on at least a portion of the main body to display a direction thereon with respect to a geographic cardinal direction; a lachrymatory agent spray disposed on at least a portion of the main body to dispense a lachrymatory agent therefrom; a light disposed on at least a portion of the main body to illuminate a surrounding area of the main body; and a blade movably disposed on at least a portion of the main body to move from retracted within the main body in a first position to at least partially extended away from the main body in a second position, and move from extended away from the main body in the second position to retracted within the main body in the first position.

### BACKGROUND

### 1. Field

The present general inventive concept relates generally to a survival device, and particularly, to a multitool survival device.

### 2. Description of the Related Art

Violent crime remains a continuing problem. Some of the most serious violent crimes include robbery, rape, kidnapping, and/or murder. More often than not, victims are unable to escape an attacker and/or protect themselves. Generally, the victims are helpless because of lack of self-defense techniques, strength imbalance between the victim and the attacker, and/or a lack of a weapon/defense tool.

Some defense weapons include a gun that are not easily obtainable.

Additionally, many people are uncomfortable carrying and/or using the gun as a means of self-defense. Also, the gun provides no other functions in a survival situation, such as being trapped in a vehicle and/or signaling for help.

Therefore, there is a need for an alternative tool for survival in a variety of situations.

### SUMMARY

The present general inventive concept provides a multitool survival device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a multitool survival device, including a main body, a glass breaker disposed on at least a portion of the main body to shatter at least a portion of a glass surface in response to moving the glass breaker against the glass surface, a seatbelt cutter disposed on at least a portion of the main body to cut a seatbelt of a vehicle in response to moving the seatbelt cutter against the seatbelt, a compass disposed on at least a portion of the main body to display a direction thereon with respect to a geographic cardinal direction; a lachrymatory agent spray disposed on at least a portion of the main body to dispense a lachrymatory agent therefrom; a light disposed on at least a portion of the main body to illuminate a surrounding area of the main body; and a blade movably disposed on at least a portion of the main body to move from retracted within the main body in a first position to at least partially extended away from the main body in a second position, and move from extended away from the main body in the second position to retracted within the main body in the first position.

The main body may include a first section, a second section disposed on at least a portion of the first section, and a blade receiving groove linearly disposed between the first section and the second section to receive the blade therein.

The multitool survival device may further include a solar cell disposed on at least a portion of the main body to provide power to the light.

The solar cell may include a charging port to charge at least one external device connected thereto.

The multitool survival device may further include a combustion chamber disposed within at least a portion of the main body to explode in response to an application of force thereon.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a multitool survival device with a blade in a retracted position, according to an exemplary embodiment of the present general inventive concept; and

FIG. 2 illustrates a side perspective view of the multitool survival device with the blade in a partially extended position, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Multitool Survival Device 100
Main Body 110
First Section 111
Concave Portions 111a
Rounded Tip 111b
Second Section 112
Concave Portions 112a
Rounded tip 112b
Blade Receiving Groove 113
Textured Surface 114
Wrist Band 115
Clip Switch 116
Hinge 117
Glass Breaker 120
Seatbelt Cutter 130
Compass 140
Lachrymatory Agent Spray 150
Nozzle 151
Button 152
Lachrymatory Agent Container 153
Light 160
Blade 170
Power Source 180
Charging Port 181
Combustion Chamber 190

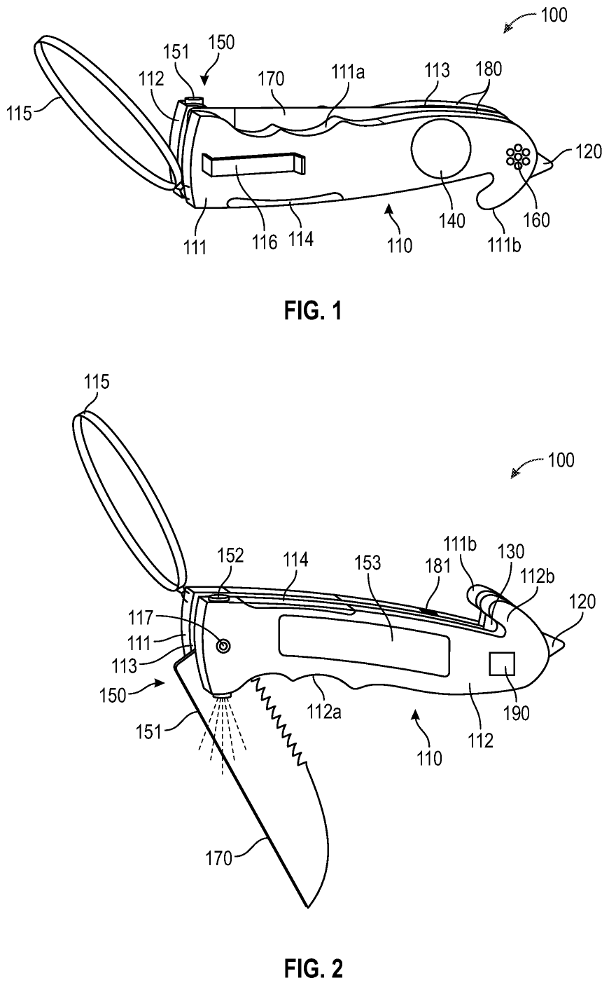

FIG. 1 illustrates a side perspective view of a multitool survival device 100 with a blade 170 in a retracted position, according to an exemplary embodiment of the present general inventive concept.

FIG. 2 illustrates a side perspective view of the multitool survival device 100 with the blade 170 in a partially extended position, according to an exemplary embodiment of the present general inventive concept.

The multitool survival device 100 may be constructed from at least one of metal, plastic, wood, glass, ceramic, and rubber, etc., but is not limited thereto.

Referring to FIGS. 1 and 2, the multitool survival device 100 may include a main body 110, a glass breaker 120, a seatbelt cutter 130, a compass 140, a lachrymatory agent spray 150, a light 160, a blade 170, a power source 180, and a combustion chamber 190, but is not limited thereto.

The main body 110 may include a first section 111, a second section 112, a blade receiving groove 113, a plurality of textured surfaces 114, a wrist band 115, a clip switch 116, and a hinge 117, but is not limited thereto.

The first section 111 may be disposed on at least a portion of the second section 112. In other words, the second section 112 may be disposed on at least a portion of the first section 111.

The first section 111 may include a plurality of concave portions 111a and a rounded tip 111b, but is not limited thereto.

The plurality of concave portions 111a may be disposed on at least a portion of the first section 111. In effect, the plurality of concave portions 111a may facilitate gripping thereof.

The rounded tip 111b may be curvedly disposed on at least a portion of a first end of the first section 111. Moreover, the rounded tip 111b may curve toward a second end of the first section 111 opposite with respect to the first end of the first section 111.

The second section 112 may include a plurality of concave portions 112a and a rounded tip 112b, but is not limited thereto.

The plurality of concave portions 112a may be disposed on at least a portion of the second section 112. In effect, the plurality of concave portions 112a may facilitate gripping thereof.

The rounded tip 112b may be curvedly disposed on at least a portion of a first end of the second section 112. Moreover, the rounded tip 112b may curve toward a second end of the second section 112 opposite with respect to the first end of the second section 112.

Therefore, the plurality of concave portions 111a and/or the rounded tip 111b of the first section 111 may correspond to and/or have the same shape and/or size as the plurality of concave portions 112a and/or the rounded tip 112b of the second section 112.

The blade receiving groove 113 may be linearly disposed between at least a portion of the first section 111 and/or at least a portion of the second section 112. Additionally, the blade receiving groove 113 may at least partially separate the first section 111 from the second section 112.

Each of the plurality of textured surfaces 114 may include a rubber surface, a gritted surface (i.e. sandpaper), and a knurled surface, but is not limited thereto.

The plurality of textured surfaces 114 may be disposed on at least a portion of the first section 111 and/or the second section 112. The plurality of textured surfaces 114 may facilitate gripping thereof, such that each of the plurality of textured surfaces 114 may increase a friction level thereto.

The wrist band 115 may be disposed on at least a portion of the second end of the first section 111 and/or the second end of the second section 112. The wrist band 115 may receive at least a portion of a limb (e.g., a wrist, a finger, a hand, an arm, a toe, an ankle, a leg) of a user therein. As such, the wrist band 115 may facilitate holding the main body 110.

The clip switch 116 may be disposed on at least a portion of the first section 111. The clip switch 116 may connect to an external object, such as a belt, pants of the user, and/or a portion of a body of the user. As such, the clip switch 116 may facilitate suspending the main body 110 therefrom.

The hinge 117 may include a ball detent, but is not limited thereto.

The hinge 117 may be disposed on and/or within at least a portion of the main body 110. More specifically, the hinge 117 may extend from the first section 111 to at least a portion of the second section 112.

The glass breaker 120 may be disposed on at least a portion of the first end of the first section 111 and/or the first end of the second section 112. The glass breaker 120 may have a conical shape. Therefore, the glass breaker 120 may shatter at least a portion of a glass surface in response to moving the glass breaker 120 and/or the main body 110 against the glass surface, such that the glass breaker 120 contacts the glass surface. Accordingly, the glass breaker 120 may help the user remove the glass surface during an emergency situation, such as being trapped in a vehicle after an accident.

The seatbelt cutter 130 may include a cutting surface, but is not limited thereto.

The seatbelt cutter 130 may be disposed on at least a portion of the first end of the first section 111 and/or the first end of the second section 112. More specifically, the seatbelt cutter 130 may be disposed between the rounded tip 112a of the first section 111 and/or the rounded tip 112b of the second section 112. During use, the seatbelt cutter 130 may cut at least a portion of the external object, such as a seatbelt of the vehicle in response to moving the seatbelt cutter 130 and/or the main body 110 against the seatbelt, such that the seatbelt cutter 130 contacts the seatbelt. Accordingly, the seatbelt cutter 130 may help the user remove the seatbelt during the emergency situation, such as being trapped in the vehicle after the accident.

The compass 140 may be disposed on at least a portion of the first section 111 and/or the second section 112, such that the compass 140 is flush with an outer surface of the first section 111 and/or the second section 112. The compass 140 may display a direction thereon with respect to a geographic cardinal direction (e.g., north, south, east, west). As such, the compass 140 may prevent the user from getting lost and/or determine a direction of travel.

The lachrymatory agent spray 150 may include a nozzle 151, a button 152, and a lachrymatory agent container 153, but is not limited thereto.

The nozzle 151 may be disposed on at least a portion of the first section 111 and/or the second section 112. The nozzle 151 may dispense (i.e. spray) a lachrymatory agent from the lachrymatory agent container 153 in response to depressing the button 152. In other words, the lachrymatory agent container 153 may store the lachrymatory agent therein.

Also, the lachrymatory agent stored in the lachrymatory agent container 153 may include a pepper spray, an oleoresin capsicum spray, a capsaicin spray, a pelargonic acid vanillylamide (PAVA), a bromoacetone spray, a phenacyl chloride (CN) spray, and/or a tear gas, but is not limited thereto. As such, the lachrymatory agent spray 150 may disable and/or incapacitate at least one third party attacker in response to being sprayed.

The light 160 may include a light-emitting diode (LED), a halogen lamp, a fluorescent bulb, and an incandescent bulb, but is not limited thereto.

The light 160 may be disposed on at least a portion of the first section 111 and/or the second section 112. Also, the light 160 may be mechanically and/or electrically connected to the clip switch 116. The light 160 may illuminate a surrounding area of the main body 110 in response to moving (i.e. sliding) the clip switch 116. Therefore, the light 160 may facilitate visibility by the user in a low light and/or dark condition.

The blade 170 may be edged, smooth, and/or serrated, but is not limited thereto.

The blade 170 may be movably (i.e. pivotally and/or rotatably) disposed within the blade receiving groove 113 via the hinge 117. In other words, the blade 170 may be disposed between at least a portion of the first section 111 and/or at least a portion of the second section 112. The blade 170 may move from retracted within the blade receiving groove 113 in a first position to at least partially extended away from the blade receiving groove 113 in a second position. Conversely, the blade 170 may move from extended away from the blade receiving groove 113 in the second position to retracted within the blade receiving groove 113 in the first position. Moreover, the blade 170 may cut the external object, a surface, and/or the at least one third party attacker. As such, the blade 170 may allow the user to self-defend.

The power source 180 may include a charging port 181, but is not limited thereto.

The charging port 181 may include a universal serial bus (USB) port, but is not limited thereto.

Furthermore, the power source 180 may include a solar cell and a battery, but is not limited thereto.

The power source 180 may be disposed on and/or within at least a portion of the first section 111 and/or the second section 112. The power source 180 may provide power to the light 160 and/or the charging port 181. As such, the charging port 181 may charge at least one external device connected thereto.

The combustion chamber 190 may include compounds such as trinitrotoluene (TNT), triacetone triperoxide (TATP), RDX, pentaerythritol tetranitrate (PETN), aziroazide azide, and/or any other explosive compound, but is not limited thereto.

The combustion chamber 190 may be disposed within at least a portion of the first section 111 and/or the second section 112. The combustion chamber 190 may explode in response to an application of force directly on the combustion chamber 190. However, the combustion chamber 190 may be specifically designed to resist explosion unless the force is applied directly on the combustion chamber 190, such that the contents therein may be agitated to a predetermined level to explode. For example, the combustion chamber 190 may be a means of last resort to escape a building and/or the at least one third party attacker.

Also, the difference in compounds within the combustion chamber 190 may be based on properties of the compounds and reactivity to explosion. For example, TNT is less explosive than TATP.

Therefore, the multitool survival device 100 may allow the user to survive a variety of different situations.

The present general inventive concept may include a multitool survival device 100, including a main body 110, a glass breaker 120 disposed on at least a portion of the main body 110 to shatter at least a portion of a glass surface in response to moving the glass breaker 120 against the glass surface, a seatbelt cutter 130 disposed on at least a portion of the main body 110 to cut a seatbelt of a vehicle in response to moving the seatbelt cutter 130 against the seatbelt, a compass 140 disposed on at least a portion of the main body 110 to display a direction thereon with respect to a geographic cardinal direction; a lachrymatory agent spray 150 disposed on at least a portion of the main body 110 to dispense a lachrymatory agent therefrom; a light 160 disposed on at least a portion of the main body 110 to illuminate a surrounding area of the main body 110; and a blade 170 movably disposed on at least a portion of the main body 110 to move from retracted within the main body 110 in a first position to at least partially extended away from the main body 110 in a second position, and move from extended away from the main body 110 in the second position to retracted within the main body 110 in the first position.

The main body 110 may include a first section 111, a second section 112 disposed on at least a portion of the first section 111, and a blade receiving groove 113 linearly disposed between the first section 111 and the second section 112 to receive the blade 170 therein.

The multitool survival device 100 may further include a solar cell disposed on at least a portion of the main body 110 to provide power to the light 160.

The solar cell may include a charging port 181 to charge at least one external device connected thereto.

The multitool survival device 100 may further include a combustion chamber 190 disposed within at least a portion of the main body 110 to explode in response to an application of force thereon.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A multitool survival device, comprising:
a main body;
a glass breaker disposed on at least a portion of the main body to shatter at least a portion of a glass surface in response to moving the glass breaker against the glass surface;
a seatbelt cutter disposed on at least a portion of the main body to cut a seatbelt of a vehicle in response to moving the seatbelt cutter against the seatbelt;
a compass disposed on at least a portion of the main body to display a direction thereon with respect to a geographic cardinal direction;
a lachrymatory agent spray disposed on at least a portion of the main body to dispense a lachrymatory agent therefrom;
a light disposed on at least a portion of the main body to illuminate a surrounding area of the main body; and
a blade movably disposed on at least a portion of the main body to move from retracted within the main body in a first position to at least partially extended away from the main body in a second position, and move from extended away from the main body in the second position to retracted within the main body in the first position.

2. The multitool survival device of claim 1, wherein the main body comprises:
a first section;
a second section disposed on at least a portion of the first section; and
a blade receiving groove linearly disposed between the first section and the second section to receive the blade therein.

3. The multitool survival device of claim 1, further comprising:
a solar cell disposed on at least a portion of the main body to provide power to the light.

4. The multitool survival device of claim 3, wherein the solar cell comprises:
a charging port to charge at least one external device connected thereto.

5. The multitool survival device of claim 1, further comprising:
a combustion chamber disposed within at least a portion of the main body to explode in response to an application of force thereon.
